(19) United States
(12) Patent Application Publication
(10) Pub. No.: US 2018/0171158 A1
(43) Pub. Date: Jun. 21, 2018

(54) TUNGSTEN-DOPED STANNIC OXIDE COLLOIDAL SUSPENSION AND METHOD FOR PREPARING THE SAME

(71) Applicants: ESSILOR INTERNATIONAL (COMPAGNIE GENERALE D'OPTIQUE), Charenton-le-Pont (FR); SHANGHAI UNIVERSITY, Shanghai (CN)

(72) Inventors: Jian ZHAO, Singapore (SG); Stéphanie PEGA, Charenton-le-Pont (FR); Liyi SHI, Shanghai (CN); Shuai YUAN, Shanghai (CN); Zhuyi WANG, Shanghai (CN); Yin ZHAO, Shanghai (CN)

(21) Appl. No.: 15/570,595

(22) PCT Filed: May 19, 2015
(86) PCT No.: PCT/CN2015/079279

§ 371 Date: Oct. 30, 2017

(51) Int. Cl. C09D 5/24; C09D 7/40; C09D 139/06; C01G 19/02; G02B 1/16

(52) U.S. Cl. CPC C09D 5/24; C09D 7/67; C08K 2003/2258; C01G 19/02; G02B 1/16; C09D 139/06

(57) ABSTRACT

A colloidal suspension of tungsten-doped SnO₂ particles is provided. It also pertains to the method for preparing such colloidal suspension and to its uses, especially in the manufacture of an antistatic coating for an optical article, such as an ophthalmic lens.

### FIELD OF THE INVENTION

The present invention pertains to a colloidal suspension of tungsten-doped SnO₂ particles (TTO nanoparticles). It also pertains to the method for preparing such colloidal suspension and to its uses, especially in the manufacture of an antistatic coating for an optical article, such as an ophthalmic lens.

### BACKGROUND OF THE INVENTION

Optical articles typically comprise a transparent optical substrate coated with an optional primer, an abrasion-resistant coating (or hard-coat) and possibly other layers such as an anti-reflection coating.

These optical articles are usually made of substantially insulating materials and tend to have their surface becoming easily charged with static electricity, particularly when cleaned under dry conditions by rubbing their surface with a wiping cloth, a piece of synthetic foam or of polyester. This phenomenon is called triboelectricity. Charges present on the surface thereof do create an electrostatic field able of attracting and retaining dust particles.

In order to counter this phenomenon, it is necessary to reduce the electrostatic field intensity, that is to say to reduce the number of static charges present on the article surface. This may be done by inserting into the stack of layers of the optical article a layer of a conducting material which dissipates the charges, also called an “antistatic coating”.

Such an antistatic coating may form the outer layer of the stack, or an intermediate layer thereof. For instance, it may be directly deposited onto the transparent optical substrate.

A typical antistatic material is TCO (transparent conductive oxide), which refers to an important class of photoelectric materials providing both electrical conductivity and optical transparency.

TCO materials can be divided into n-type (electron is charge carrier) and p-type (hole is charge carrier) materials. N-type TCO materials includes the Cd, In, Sn or Zn oxides or multiple complex oxides, which may be doped. Tin doped In₂O₃ (ITO) and antimony or fluorine doped SnO₂ (respectively ATO and FTO), are among the most utilized TCO thin films in modern technology. In particular, ITO is used extensively for industrial applications.

Recently, the scarcity and price of Indium needed for ITO has motivated industrial companies to find a substitute such as ATO, which has a lower cost than ITO. It has thus been suggested to use ATO for forming electrostatic coatings in optical articles (WO 2010109154, WO 2010015780). However, ATO has comparatively a lower conductivity and also a higher absorption in the visible light range than ITO. Consequently, ATO layers have limited transparency compared to ITO and a slightly blue coloration together with poorer conductivity.

As another ITO potential substitute, FTO presents the advantage of being more conductive than ATO and have a higher transparency than ATO in the visible range (less absorption). WO2014183265 discloses a process for producing a colloidal alcoholic suspension of FTO. Compared with other TCO materials, the FTO materials show also higher thermal stability, higher mechanical and chemical durability and lower toxicity. However, FTO coatings show inadequate antistatic performances.

Thus, there remains the need to provide TCO materials other than ITO, ATO and FTO that show high transparency, low haze and good antistatic performances.

The present inventors have developed a new TCO material which includes tungsten-doped tin oxide nanocrystals (TTO) that satisfies this need.

### SUMMARY OF THE INVENTION

A first aspect of the invention is a colloidal suspension of tungsten-doped stannic oxide nanoparticles having a W:Sn molar ratio higher than or equal to 0.0004.

A further aspect of the invention is a substrate coated with a composition comprising the colloidal suspension according to the invention.

A further aspect of the invention is a method for producing said colloidal suspension, said method comprising the following steps:

a) adding stannous oxalate and hydrogen peroxide into deionized water under stirring so as to obtain a clear solution;
b) dispersing tungsten powder into the clear solution under agitation so as to obtain a suspension;
c) adding hydrogen peroxide to the suspension;
d) subjecting the suspension obtained at step c) to hydrothermal treatment so as to obtain a colloidal aqueous suspension of tungsten-doped stannic oxide nanoparticles;
e) concentrating the colloidal aqueous suspension of tungsten-doped stannic oxide nanoparticles so as to increase its dry matter content thereby obtaining a concentrated suspension;
f) optionally dispersing said concentrated suspension into an alcohol selected from methanol, ethanol, propanol or butanol, a glycol, a glycol ether, a ketone or a mixture thereof and oxalic acid dihydrate so as to obtain a colloidal suspension of tungsten-doped stannic oxide nanoparticles.

The TTO colloidal suspension of the invention allows the formation of an antistatic hard coating having good antistatic performances, low yellowness and a transparency which is higher than the one obtained with ATO nanoparticles, which is an outstanding advantage.

The colloidal suspension of the invention can be dispersed well in an aqueous solvent and forms a stable suspension. By peptizing the TTO nanoparticles with oxalic acid, the colloidal suspension of the invention can be also well dispersed in an alcoholic solvent and form a stable suspension, thereby being able to be applied on optical substrates as very thin films (<100 nm) by wet coating at mild temperature or to be introduced in typical sol-gel formulations used for the formation of optical hard-coatings.

The TTO colloidal suspension of the invention can be prepared easily by a hydrothermal synthesis which does not use rare, expensive or harmful reactants.

### DETAILED DESCRIPTION OF THE INVENTION

The present invention is drawn to a colloidal suspension of tungsten-doped stannic oxide nanoparticles.

Tungsten (W) is known as a good dopant for In₂O₃ and TiO₂-based TCOs. Tungsten can also be used as a doping agent for SnO₂ nanocrystals. Without being bound by this theory, it is assumed that by having a radius close to that one of Sn⁴⁺ (W⁶⁺:60 pm; Sn⁴⁺: 69 pm), W⁶⁺ is able to replace Sn⁴⁺ ions in the SnO₂ lattice and generate more carriers than other common dopants for SnO₂ films. The replacement of tin by tungsten in the lattice of SnO₂ brings free electrons and improves the conductivity of the material.

The tungsten-doped stannic oxide nanoparticles of the invention are thus stannic oxide (SnO₂) nanocrystals in which some metallic Sn sites are occupied by W atoms instead of Sn atoms. Tungsten is thus included in the lattice of tin oxide.

It is worth noting that the tungsten-doped stannic oxide nanoparticles of the invention are not composite SnO2:WO3 nanoparticles (or mixed oxides) as disclosed in the prior art U.S. Pat. No. 5,094,691, EP0573304, EP0574274 or EP1193285. In contrast to the tungsten-doped tin oxide nanoparticles of the invention, the product disclosed in this prior art is a composite material wherein two different oxides (WO₃ and SnO₂) are aggregated into nanoparticles having a weight ratio WO₃/SnO₂ from 0.5 to 100 (the molar ratio W:Sn=0.3-64.7).

The tungsten-doped stannic oxide nanoparticles of the invention have a W:Sn molar ratio higher than or equal to 0.001. The W:Sn molar ratio represents the number of moles of tungsten atoms over the number of moles of tin atoms in the tungsten-doped tin oxide nanoparticles. It can be measured by Inductively Coupled Plasma Optical Emission Spectrometry (ICP-OES), for instance with a PERKINE 7300DV ICP-OES spectrometer.

In one embodiment, the W:Sn molar ratio is higher than or equal to 0.001, or higher than or equal to 0.002, or higher than or equal to 0.003, or higher than or equal to 0.004, or higher than or equal to 0.005, or higher than or equal to 0.006, or higher than or equal to 0.007.

In one embodiment, the W:Sn molar ratio is lower than or equal to 0.15, in particular lower than or equal to 0.05, more particularly lower than or equal to 0.03.

The tungsten-doped nanoparticles of the invention can be dispersed in water or various organic solvents such as alcohols, in particular methanol, ethanol, propanol or butanol, or in glycols, glycol ethers, ketones or mixtures thereof.

In one embodiment, the solvent of the suspension is a mixture of water and alcohol, such as methanol, ethanol, propanol or butanol.

The volume ratio of alcohol to water preferably ranges from 80:1 to 100:0, preferably from 90:1 to 100:0.

The colloidal suspension of the invention shows a better dispersion and stability in aqueous solvents compared to organic solvents.

The inventors have found that the dispersion and stability of the colloidal suspension of the invention in organic solvents can be significantly improved by anchoring oxalic acid molecules on the surface of the TTO nanoparticles.

Therefore, when the TTO nanoparticles of the invention are dispersed in an organic solvent, the colloidal suspension preferably further comprises oxalic acid dihydrate for peptization.

Thus, another object of the invention is a colloidal suspension of tungsten-doped stannic oxide nanoparticles in an organic solvent, wherein surface of said nanoparticles is modified with oxalic acid molecules.

The TTO nanoparticles of the invention are polycrystalline materials.

The mean particle size can be calculated by using a Scherrer equation from X-Ray Diffraction (XRD) data according to the Full Width At Half Maximum (FWHM) of the (110) peak. The XRD measurement may be performed with a Rigaku D/MAX-RB diffractometer using Cu Kα radiation from a powder sample which is obtained by drying the TTO colloidal suspension at 110° C.

In addition, the mean particle size can be determined from TEM images, by averaging the size observed for a collection of particles, typically 50 particles. In the invention, TTO nanoparticles present a low aspect ratio (length divided by width) lower than 2. The particle size corresponds to the average between the observed length and the observed width. In the invention, mean particle size obtained from XRD and TEM measurements are consistent.

In one embodiment, the TTO nanoparticles of the invention have a mean particle size ranging from 4 to 20 nm, in particular from 6 nm to 12 nm.

The TTO nanoparticles of the invention are conductive materials. The sheet resistance of TTO was measured by the following process. First, the solvent of the TTO nanoparticles suspension is evaporated by rotary evaporation and a TTO powder is obtained. Second, the TTO powder is dried in oven. Third, 0.6 g TTO powder is pressed into a tablet with diameter 10 mm and thickness 2 mm under 3 MPa. Last, conductivity of TTO tablet is measured by the standard four-probe method, for instance by using a SDY-5 four-point probe meter.

The TTO colloidal suspension of the invention can be used in the manufacture of an antistatic hard coating for a substrate.

Thus, another object of the invention is a substrate coated with a composition comprising the TTO colloidal suspension as previously described. The substrate may be an optical article, such as an ophthalmic or an optical lens, or a display or touch screen.

The transparent substrate of the optical article of the present invention can be any substrate commonly used in the field of optics and in particular in the ophthalmic field. It is, for example, an organic glass composed of a thermoplastic or thermosetting plastic.

Thermoplastic material may be selected from, for instance: polyamides; polyimide; polysulfones; polycarbonates; poly(ethylene terephtalate) and polymethylmethacrylate (PMMA). and copolymers thereof

Thermoset materials may be selected from, for instance: cycloolefin copolymers such as ethylene/norbornene or ethylene/cyclopentadiene copolymers; homo- and copolymers of allyl carbonates of linear or branched aliphatic or aromatic polyols, such as homopolymers of diethylene glycol bis(allyl carbonate) (CR 39®); homo- and copolymers of (meth)acrylic acid and esters thereof, which may be derived from bisphenol A; polymer and copolymer of thio(meth)acrylic acid and esters thereof; polymer and copolymer of allyl esters which may be derived from Bisphenol A or phtalic acids and allyl aromatics such as styrene; polymer and copolymer of urethane and thiourethane; polymer and copolymer of epoxy; and polymer and copolymer of sulphide, disulfide and episulfide, and combinations thereof.

As used herein, a (co)polymer is intended to mean a copolymer or a polymer. As used herein, a (meth)acrylate is intended to mean an acrylate or a methacrylate. As used herein, a polycarbonate (PC) is intended to mean either homopolycarbonates or copolycarbonates and block copolycarbonates.

In particular, a diethylene glycol bis(allyl carbonate), such as CR39®, in particular with a refractive index of 1.5, sold by PPG Industries, allylic and (meth)acrylic copolymers, having a refractive index between 1.54 and 1.58, a polythiourethane, such as MR series provided by Mitsui Chemicals: MR6®, MR7®, MR8®, MR10®, MR174®, or Polycarbonate are suitable materials for substrates.

A primer may be applied onto the substrate, for instance by dip coating or spin coating, to improve the impact strength of the subsequent layers in the final product. In addition, the primer makes it possible to ensure good adhesion of the abrasion-resistant coating to the substrate. This primer usually has a thickness of from 0.05 to 20 μm, for instance from 0.5 to 5 μm. It may be chosen from organic latex materials having a particle size of less than 50 nm and preferably less than 20 nm. A method for applying the primer onto the substrate is given for instance in Example 1 of U.S. Pat. No. 5,316,791.

The optical article also generally includes an abrasion-resistant coating which is applied directly onto the bare substrate or onto the primer.

The abrasion-resistant coating can be any layer conventionally used as abrasion-resistant coating in the field of ophthalmic lenses. Mention may be made, among the coatings recommended in the present invention, of coatings based on epoxysilane hydrolyzates, such as those described in the patents EP 0 614 957, U.S. Pat. No. 4,211,823, U.S. Pat. No. 5,015,523 and US 2005/0123771. The abrasion-resistant coating is applied by dip coating or spin coating, then dried and cured thermally or by irradiation. The abrasion-resistant coating thickness may range from 1 to 15 μm, preferably from 2 to 10 μm and more preferably from 3 to 5 μm

This abrasion-resistant coating may be coated with other layers such as an anti-reflection coating, which may be a mono- or multilayer film comprising dielectric materials such as SiO, SiO2, TiO2, ZrO2, Al2O3, MgF2, Ta2O5, PrTiO3, Al2O3, Y2O3 or mixtures thereof.

The colloidal suspension of this invention may be introduced into the formulation of the primer or abrasion-resistant coating.

Alternatively, the colloidal suspension of this invention may be included in the formulation of an antistatic coating which may be either interposed between two layers of the stack forming the optical article or applied on the external side of this stack starting from the substrate or applied directly onto the optical substrate under the stack of layers, such as the primer and the antiabrasion coating. In particular, the TTO colloidal suspension of this invention is directly applied onto the optical substrate under the stack of layers forming the optical article. Such antistatic coating composition may be applied, for instance by dip coating or spin coating, and then dried to a thickness of from 1 to 250 nm, for instance from 10 to 200 nm.

When the TTO colloidal suspension of the invention is applied on a substrate for preparing an antistatic hard coating, polyvinylpyrrolidone is preferably added to the colloidal suspension as a binder in order to improve the antistatic performances. Without being bound by this theory, it is believed that the binder helps the nanoparticles to be tightly connected one to each other. Advantageously, a coating obtained from the TTO colloidal suspension of the invention shows a higher transparency than a coating obtained from an ATO colloidal suspension.

Thus, another object of the invention is a colloidal suspension of tungsten-doped stannic oxide nanoparticles as described previously further comprising polyvinylpyrrolidone.

The antistatic performances of a coating obtained with the TTO colloidal suspension of the invention can be determined by decay time measurements (surface charge-discharge measurements).

In the present patent application, charge decay times of optical articles which have been beforehand subjected to a corona discharge at −9000 volts were measured using JCI 155v5 Charge Decay Test Unit from John Chubb Instrumentation at 25° C. and 50% relative humidity.

A coating is regarded as “antistatic” if its decay time is under 500 ms.

The decay time of a substrate according to the invention is typically lower than 500 ms, preferably lower than 200 ms.

Another object of the invention is a method for producing the TTO colloidal suspension of the invention, said method comprising the following steps:
a) adding stannous oxalate and hydrogen peroxide into deionized water under stirring so as to obtain a clear solution;
b) dispersing tungsten powder into the clear solution under agitation so as to obtain a suspension;
c) adding hydrogen peroxide to the suspension;
d) subjecting the suspension obtained at step c) to hydrothermal treatment so as to obtain a colloidal aqueous suspension of tungsten-doped stannic oxide nanoparticles;
e) optionally concentrating the colloidal aqueous suspension of tungsten-doped stannic oxide nanoparticles so as to increase its dry matter content thereby obtaining a concentrated suspension;
f) optionally dispersing said concentrated suspension into an alcohol selected from methanol, ethanol, propanol or butanol, a glycol, a glycol ether, a ketone or a mixture thereof and oxalic acid dihydrate so as to obtain a colloidal suspension of tungsten-doped stannic oxide nanoparticles.

In the first step a) of this method, stannous oxalate (SnC₂O₄) is used as a precursor of stannic oxide.

Stannous oxalate may optionally be formed in situ, i.e. before conducting the first step a) of this process, by reacting tin with oxalic acid.

Stannous oxalate is preferably dissolved in deionized water in the presence of hydrogen peroxide which aids in this dissolution by forming a tin complex. The molar ratio SnC₂O₄:H₂O₂:H₂C₂O₄ is preferably 1:1:1.

This step may be conducted in the presence of an acid other than hydrochloric acid, such as oxalic acid dihydrate and/or nitric acid, for obtaining a good dissolution of the precursor of stannic oxide.

Tungsten powder (e.g. commercially available from Sinopharm, as particles with diameter below 75 μm and purity higher than 99.8%) is then added to this mixture under agitation so as to obtain a suspension (step b). The agitation may be performed by mechanical steering or by ultrasonication with an ultrasonic instrument.

Other Tungsten precursors may be used, like Tungstic acid (WO3), Sodium Tungstate dihydrate (Na2WO4.2H2O) or other Tungsten salts.

In order to have a good conductivity, the molar ratio of tungsten to stannous oxalate in solution preferably ranges from 0.5:100 to 2.5:100, preferably from 1:100 to 2:100 and is more preferably of 1.5:100.

Then, a second amount of hydrogen peroxide is added to this mixture (step c) as a provider of an oxygen source for the formation of stannic oxide during the hydrothermal treatment.

In order to have a good conductivity, the molar ratio of the second amount of hydrogen peroxide to stannous oxalate preferably ranges from 6:1 to 15:1, preferably from 9:13 to 15:1 and is more preferably of 12:1.

This mixture is then subjected to a hydrothermal treatment (step d), which may be conducted in an autoclave, for instance during 6 to 72 hours and preferably from 20 to 36 hours, preferably during around 24 hours, at a temperature of 120 to 220° C., preferably from 160 to 200° C., more preferably around 170° C.

Without being bound by any theory, inventors observed that during hydrothermal treatment, Tungsten reacts with hydrogen peroxide and yield hydrated Tungsten species which are able to substitute Tin ions while Tin oxide crystal is growing.

This hydrothermal treatment results in a grey-green suspension of tungsten-doped stannic oxide particles.

The process described above may also comprise a step of concentration (step e) of the suspension obtained from step d, in order to increase its dry matter content. The suspension may be concentrated, for instance, by evaporation or by ultrafiltration, in order to obtain a colloidal suspension of tungsten-doped stannic oxide nanoparticles with a solids content ranging from 5 to 20% by weight and preferably from 8 to 15% by weight.

The concentrated suspension thus obtained may be then dispersed into an organic solvent (step f), for instance an alcohol selected from methanol, ethanol, propanol or butanol, a glycol, a glycol ether, a ketone or a mixture thereof.

Preferably, oxalic acid dihydrate is added to the organic solvent as a peptization agent in order to improve the dispersion and stability of the colloidal suspension of the invention in said organic solvent.

The weight ratio of oxalic acid to TTO nanoparticles preferably ranges from 0.05:1 to 0.10:1, preferably from 0.08:1 to 0.10:1 and is more preferably of 0.10:1.

As discussed previously, polyvinylpyrrolidone may also be added to the colloidal suspension as a binder in order to improve the antistatic performances of the hard coating. Accordingly, polyvinylpyrrolidone may be added to the colloidal aqueous suspension of tungsten-doped stannic oxide nanoparticles obtained in step d) or to the colloidal suspension of tungsten-doped stannic oxide nanoparticles obtained in step f).

The weight ratio of polyvinylpyrrolidone to TTO nanoparticles preferably ranges from 0.06:1 to 0.08:1, preferably from 0.06:1 to 0.07:1 and is more preferably of 0.06:1. Preferably, the molecular weight of polyvinylpyrrolidone is from 25000 to 50000.

The method of this invention results in a transparent colloidal suspension of tungsten-doped stannic oxide particles, which has a zeta potential (absolute value) of more than 30 mV, preferably of more than 40 mV and more preferably of more than 50 mV, in absolute value, which reflects the high dispersion of the particles. The zeta potential may be measured for instance with a Zetasizer 3000HS (Malvern Instrument). This high zeta potential is still measured after 60 days of storage at room temperature. The high dispersion of the suspension obtained according to this invention may also be observed by transmission electron microscopy (TEM) and UV-Visible spectroscopy (which shows no sedimentation).

### EXAMPLES

This invention will be further illustrated by the following non-limiting examples which are given for illustrative purposes only and should not restrict the scope of the appended claims.

### Example 1: Preparation of a Tungsten-Doped Stannic Oxide Colloidal Suspension

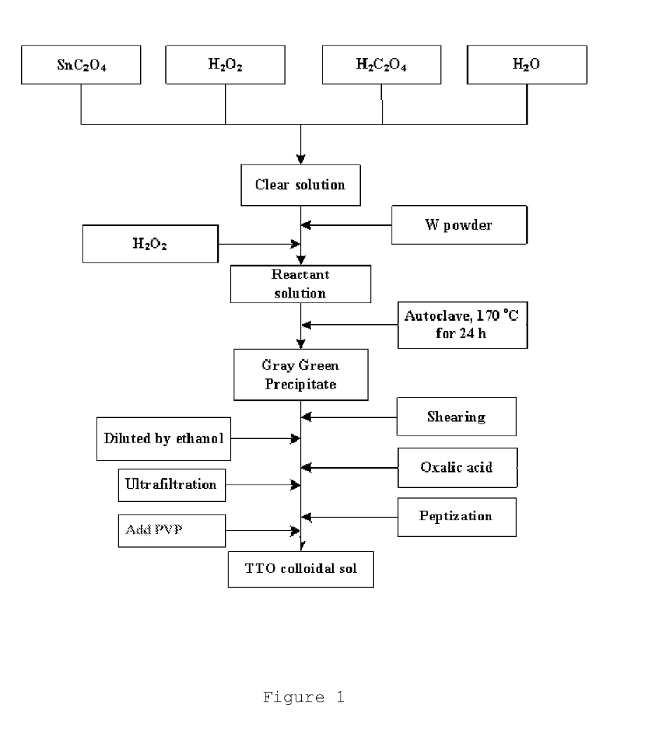

FIG. 1 shows the synthesis route for the preparation of a TTO colloidal suspension. The experimental procedure is described hereafter.

### Materials:

Stannous oxalate (Sn2C2O4), oxalic acid (H2C2O4), tungsten powder (W) and hydrogen peroxide (H2O2) were of analytical grade without further purification (Sinopharm Chemical Reagent Co., Ltd.); deionized water was used in the experiment. The particle size of the tungsten powder is smaller than 74 micrometer.

### Preparation of TTO Nanoparticles

The TTO nanoparticles with diameter size ranging from 9 to 13 nm were synthesized by hydrothermal method. In a typical procedure, stannous oxalate, oxalic acid dihydrate and hydrogen peroxide were added into deionized water with strongly stirring until the solution turned into clear. Then tungsten powder was dispersed into the solution by an ultrasonic instrument (SY-360, Shanghai Ningshang ultrasonic instrument Co., Ltd.) for 20 min before adding a second amount of hydrogen peroxide into the solution (molar ratio H2O2:SnC2O4=11:1). The molar ratio of tungsten concentration over stannous oxalate was determined to be 1.5%. Finally, the solution was transferred to a 100 ml Teflon autoclave and heated at 170° C. for 24 h to form TTO nanocrystals.

### Preparation of TTO Colloidal Suspension

After hydrothermal reaction, the supernate was separated directly and the sediments were stirred forcefully by a high-speed shear machine (DS-20/PG, ART Prozess- & Labortechnik GmbH & Co. KG) for 2 min. Then, the prepared TTO nanocrystals were dispersed into ethanol by ultrasonic cell crasher (XQ-1000D, Nanjing Xian'ou biological Technology Co., Ltd.) to form a TTO colloidal suspension in ethanol. The additional oxalic acid dihydrate was added into this colloid as a peptization agent (stabilizer). In the end, the colloid was washed and concentrated with ethanol until the conductivity was stabilized at the lowest point and the dry content was 6% by using membrane equipment (Sartorius, 10,000 MWCO HY).

Optionally, PVP (K30 grade) was added to the colloid with different PVP/TTO ratio.

The key parameters in the synthesis process are described in table 1. Hydrogen peroxide considered in this table does not comprise the second amount of hydrogen peroxide added at step c):

TABLE 1

| Synthesis Parameters | |
|---|---|
| Tin precursor | Stannous oxalate (SnC₂O₄) |
| Tungsten precursor | W metal powder |
| Molar ratio H₂O₂:SnC₂O₄ | 1:1 |
| Molar ratio C₂H₂O₄:SnC₂O₄ | 1:1 |
| Molar ratio W:Sn | 0.015:1 |
| Hydrothermal temperature | 170° C. |
| Hydrothermal time | 24 h |
| Peptization by oxalic acid | 0.10:1 |
| Weight ratio C₂H₂O₄:TTO | |
| PVP additive binder | 0.06:1 |
| Weight ratio PVP:TTO | |

### TTO Characterizations

The TTO colloidal suspension was deposited in a copper-coated carbon grid for investigation by field emission transmission electron microscopy (TEM, JEOL JEM-2010F) and high-resolution transmission electron microscopy (HRTEM, JEOL 3010 ARP) microscope, with the microscope operated at an acceleration voltage of 300 kV. TEM allows characterization of the morphology and nanoparticle size and HRTEM allows characterization of the morphology, nanoparticle size, crystal face and crystallinity.

Powder samples were obtained after the colloidal suspension was dried at 110° C., and then investigated by an X-ray diffraction (XRD) analysis with a Rigaku D/MAX-RB diffractometer using Cu Kα radiation.

Particle size is around 11 nm (TEM & XRD).

Tungsten content in tin dioxide was studied by Inductively Coupled Plasma Optical Emission Spectrometry (ICP) by a PERKINE 7300DV coupled plasma atomic emission spectrometer.

XRD diagram and ICP analysis showed that W atoms were inserted in typical SnO₂ crystalline structure with various molar ratio of W:Sn from 0.0004 to 0.0067.

Sheet resistances were measured by the standard four-probe method using a SDY-5 four-point probe meter.

The resistance sheet of the TTO powder was about 30-35 ohm/square.

Table 2 shows characteristics of TTO colloidal suspensions obtained with various experimental conditions: compositions in Tin precursor (SnC₂O₄), hydrogen peroxide (H₂O₂), oxalic acid (H₂C₂O₄) and metallic Tungsten (W). Hydrogen peroxide considered in this table does not comprise the second amount of hydrogen peroxide added at step c).

TABLE 2

| | | | | | Time of | | | |
|---|---|---|---|---|---|---|---|---|
| | | | | | Hydro- | | | |
| Molar composition of the | | | | Hydrothermal | thermal | | | W:Sn |
| reaction solution | | | | Temperature | treatment | Dxrd | Dtem | (by |
| SnC2O4 | H2O2 | H2C2O4 | W | (° C.) | (hours) | (nm) | (nm) | ICP) |
| 1 | 1 | 1 | 0.000 | 170 | 24 | 12.38 | 9.92 | 0 |
| 1 | 1 | 1 | 0.005 | 170 | 24 | 12.14 | 9.86 | 0.0016 |
| 1 | 1 | 1 | 0.015 | 170 | 24 | 10.95 | 7.80 | 0.0067 |
| 1 | 1 | 1 | 0.025 | 170 | 24 | 10.55 | 6.23 | 0.0035 |
| 1 | 0.5 | 1 | 0.015 | 170 | 24 | 11.24 | 8.71 | 0.0027 |
| 1 | 1.25 | 1 | 0.015 | 170 | 24 | 10.51 | 7.79 | 0.0046 |
| 1 | 1 | 0.5 | 0.015 | 170 | 24 | 11.00 | 7.94 | 0.0008 |
| 1 | 1 | 1.5 | 0.015 | 170 | 24 | 10.73 | 7.67 | 0.0021 |
| 1 | 1 | 1 | 0.015 | 170 | 12 | 10.44 | 7.23 | 0.0030 |
| 1 | 1 | 1 | 0.015 | 170 | 36 | 11.45 | 8.25 | 0.0034 |
| 1 | 1 | 1 | 0.015 | 150 | 24 | 9.42 | 6.02 | 0.0004 |
| 1 | 1 | 1 | 0.015 | 190 | 24 | 10.73 | 7.31 | 0.0011 |

Dxrd is particle size in nm from the X-ray diffraction data. Dtem is the crystallite size in nm from the TEM image. Molar fraction of W:Sn is the molar fraction of Tungsten in TTO colloidal suspensions, measured from inductive coupled plasma emission spectrometer data.

### Example 2: Use as an Antistatic Material

### Preparation of Ophthalmic Lenses

The TTO colloidal suspension obtained with synthesis parameters of table 1 (with or without PVP) was deposited by spin-coating on the convex side of pre-cleaned CR® 39 lenses, then dried at room temperature during five minutes. The thickness of TTO colloid layer is listed in table 2.

After deposition of TTO colloids, antiabrasion coating were deposited in standard conditions. A coating of refractive index 1.5 (reference HC1.5) as described in EP0614957 and a coating of refractive index 1.6 (reference HC1.6) as described in EP0614957 with addition of high refractive index nanoparticles of TiO2 were used.

Comparative lenses were prepared as follows:
HC1.5 or HC1.6 without any TCO layer (blank);
Lenses coated in the same way as described above but wherein the TTO is replaced with an ATO conductive colloid (ELCOM V3560 supplied by JGC) diluted at 3 wt % in ethanol or with an FTO conductive colloid as described in example 1 of WO2014183265.

### Determination of the Antistatic Performances and Transparency of the Lenses:

The antistatic performance is determined by mean of charge-discharge experiments measurements. Charge decay times of optical articles which have been beforehand subjected to a corona discharge at −9000 volts during 30 s were measured using JCI 155v5 Charge Decay Test Unit from John Chubb Instrumentation at 25° C. and 50% relative humidity.

The unit was set up with JCI 176 Charge Measuring Sample Support, JCI 191 Controlled Humidity Test Chamber, JCI 192 Dry Air Supply Unit and Calibration of voltage sensitivity and decay time measurement performance of JCI 155 v5 (from John Chubb Instrumentation) to the methods specified in British Standard and Calibration voltage measurements and resistor and capacitor values traceable to National Standards

During those experiments of charge-discharge measurements, the time to reach 1/e=36.7% of the maximum tension which is called the “decay time” was determined.

A lens is considered:
highly antistatic if its decay time is measured under 200 ms,
antistatic if its decay time is under 500 ms,
slightly antistatic if its decay time is under 1 s,
Not antistatic if its decay time is larger than 1 s.

The transparency of the lenses is estimated by measuring the transmission level (Tv) of the lens according to the ISO Standard 8980-3, in the 380 nm-780 nm wavelength range, using a spectrophotometer (CARY 50). It corresponds to the transmission factor as defined in the ISO Standard 13666:1998.

HAZE value is measured by light transmission measurement using the Haze-Guard Plus© haze meter from BYK-Gardner (a color difference meter) according to the method of ASTM D1003-00. All references to “haze” values in this application are by this standard. The instrument is first calibrated according to the manufacturer's instructions. Next, the sample is placed on the transmission light beam of the pre-calibrated meter and the haze value is recorded from three different specimen locations and averaged.

Yellow Index (YI) is measured according to ASTM D-1925. YI can be determined from the CIE tristimulus values X, Y, Z through the relation: YI=(128 X−106 Z)/Y.

Results are summarized in table 3.

TABLE 3

| | | | Anti- | | | | | |
|---|---|---|---|---|---|---|---|---|
| | | TCO layer | abrasion | | JCI decay | | Haze | Yellow |
| | | thickness | coating | Tv | time | | (%) | Index |
| Comparative | No TCO | — | HC1.5 | 92.7% | 30-100 | s | 0.1 | 1.1 |
| Example 1.1 | colloid | | | | | | | |
| Comparative | FTO | 69 nm | HC1.5 | 92.0% | ~500 | ms | 0.1 | 1.2 |
| Example 2.1 | colloid | | | | | | | |
| Comparative | ATO | 68 nm | HC1.5 | 91.5% | <200 | ms | 0.1 | 1.0 |
| Example 3.1 | colloid | | | | | | | |
| Example a.1 | TTO | 167 nm | HC1.5 | 92.7% | 30 | s | 0.1 | 1.1 |
| | colloid | | | | | | | |
| Example a.2 | TTO + PVP | 120 nm | HC1.5 | 92.3% | ~500 | ms | 0.1 | 1.0 |
| | colloid | | | | | | | |
| Comparative | No TCO | — | HC1.6 | 89.6% | 3-10 | s | 0.2 | 1.7 |
| Example 1.2 | colloid | | | | | | | |
| Comparative | FTO | 69 nm | HC1.6 | 89.3% | ~500 | ms | 0.2 | 1.7 |
| Example 2.2 | colloid | | | | | | | |
| Comparative | ATO | 68 nm | HC1.6 | 88.6% | <200 | ms | 0.2 | 1.4 |
| Example 3.2 | colloid | | | | | | | |
| Example a.3 | TTO | 167 nm | HC1.6 | 89.5% | 2 | s | 0.1 | 1.9 |
| | colloid | | | | | | | |
| Example a.4 | TTO + PVP | 120 nm | HC1.6 | 89.3% | <200 | ms | 0.1 | 1.7 |
| | colloid | | | | | | | |

### Transparency:

Lenses coated with ATO layers of 68 nm (Comparative examples 3.1 and 3.2) show a lower transparency than the same lenses without any TCO layer (Comparative examples 1.1 and 1.2). On the contrary, lenses coated with 69 nm FTO or TTO layers have a transparency similar to the same lenses without any TCO layer.

### Antistatic Performances:

Reference lenses coated with HC1.5 and HC 1.6 antiabrasion coating (Comparative examples 1.1 and 1.2) show respectively decay times in the range 30-100 s and 3-10 s, which is not considered antistatic.

Lenses coated with ATO layers (Comparative examples 3.1 and 3.2) have great antistatic performances but transparency is degraded.

FTO layers (Comparative examples 2.1 and 2.2) provide an improvement in transparency compared to ATO layers (Comparative examples 3.1 and 3.2), but a degraded antistatic performance (decay time ˜500 ms with both HC1.5 and HC1.6). In addition, FTO layers do not degrade Haze and Yellow Index performances of substrates.

The TTO colloidal suspension of the invention provides an improvement in the antistatic performance compared to FTO colloidal suspension, with a premium antistatic performance with HC1.6 (example 4a) while keeping the same outstanding transparency, Haze and Yellow Index.

1. A colloidal suspension of tungsten-doped stannic oxide nanoparticles having a W:Sn molar ratio higher than or equal to 0.0004.

2. The colloidal suspension according to claim 1, wherein said W:Sn molar ratio is lower than or equal to 0.15, in particular lower than or equal to 0.05, particularly lower than or equal to 0.03.

3. The colloidal suspension according to claim 1, wherein said nanoparticles are dispersed in water, alcohols selected from methanol, ethanol, propanol or butanol, glycols, glycol ethers, ketones or a mixture thereof, preferably in a mixture of water and alcohol selected from methanol, ethanol, propanol or butanol.

4. The colloidal suspension according to claim 1, wherein the mean particle size of said nanoparticles is from 4 to 20 nm, in particular from 6 nm to 12 nm.

5. The colloidal suspension according to claim 1, wherein tungsten is included in the lattice of tin oxide.

6. The colloidal suspension according to claim 1, wherein said suspension further comprises oxalic acid dihydrate.

7. The colloidal suspension according to claim 1, wherein said suspension further comprises polyvinylpyrrolidone.

8. A substrate coated with a composition comprising the colloidal suspension according to claim 1.

9. The substrate according to claim 8, wherein said substrate is an optical article, such as an ophthalmic or an optical lens, or a display or touch screen.

10. The substrate according to claim 8, wherein the charge decay time of said substrate is lower than 1 s, preferably lower than 500 ms, more preferably lower than 200 ms.

11. A method for producing the colloidal suspension according to claim 1, said method comprising the following steps:
a) adding stannous oxalate and hydrogen peroxide into deionized water under stirring so as to obtain a clear solution;
b) dispersing tungsten powder into the clear solution under agitation so as to obtain a suspension;
c) adding hydrogen peroxide to the suspension;
d) subjecting the suspension obtained at step c) to hydrothermal treatment so as to obtain a colloidal aqueous suspension of tungsten-doped stannic oxide nanoparticles;
e) optionally concentrating the colloidal aqueous suspension of tungsten-doped stannic oxide nanoparticles so as to increase its dry matter content thereby obtaining a concentrated suspension;
f) optionally dispersing said concentrated suspension into an alcohol selected from methanol, ethanol, propanol or butanol, a glycol, a glycol ether, a ketone or a mixture thereof and oxalic acid dihydrate so as to obtain a colloidal suspension of tungsten-doped stannic oxide nanoparticles.

12. The method according to claim 11, wherein said method further comprises the concentration of the colloidal suspension of tungsten-doped stannic oxide nanoparticles obtained in step f).

13. The method according to claim 11, wherein said method further comprises the addition of polyvinylpyrrolidone to the colloidal suspension of tungsten-doped stannic oxide nanoparticles obtained in step d) or in step f).
